(19) United States
(12) Patent Application Publication
(10) Pub. No.: US 2025/0362943 A1
(43) Pub. Date: Nov. 27, 2025

(54) SHADOW CURSOR FOR USER TUTORIALS

(71) Applicant: Notion Labs, Inc., San Francisco, CA (US)

(72) Inventors: Matthew DuVall, Larkspur, CA (US); Henry Gan Roswell, Long Island City, NY (US); Annie Yu, San Francisco, CA (US)

(21) Appl. No.: 18/908,339

(22) Filed: Oct. 7, 2024

Related U.S. Application Data
(60) Provisional application No. 63/651,261, filed on May 23, 2024.

(51) Int. Cl. G06F 9/451

(52) U.S. Cl. CPC G06F 9/453

(57) ABSTRACT

A multimodal content management system having a block-based data structure can implement techniques for utilizing a shadow cursor for automatic artificial intelligence (AI)-assisted user tutorials. In one example, the system can automatically determine an entry point for a user tutorial session, where the user tutorial session relates to a training workflow predicted for the user. The system can generate and bind, to the determined entry point, a shadow cursor, the shadow cursor comprising a gradient field (e.g., a radial gradient) to visually emphasize a relevant portion of the GUI. The system can automatically guide the user through the tutorial using the shadow cursor. The training workflow can be automatically determined or generated based on user characteristics, task characteristics, or other suitable items. The shadow cursor can include additional contextual or explanatory elements to guide the user through the training workflow.

### CROSS-REFERENCE TO RELATED APPLICATIONS

This application claims the benefit of priority to U.S. Provisional Application No. 63/651,261, filed May 23, 2024, which is incorporated by reference herein in its entirety.

### BACKGROUND

Project management systems enable teams to organize work and can be used in workflow automation, task management, project planning, and file sharing. Some project management systems can be augmented via document management systems, which are designed to manage, track, and store documents, aiming to reduce the use and dependency on physical paper. A document management system can serve as a central repository, making it easy for organizations to organize data. Individuals typically search document management systems by entering keywords into a search bar.

Project and/or document management systems can be structured to store and organize complex, multimodal information and can enable various complex tasks. When system users are onboarded, it is desirable to enable users to use the system effectively without extensive training. One way to enable this is to make various system features accessible via the user interface. Accordingly, in conventional systems, various user interface components (e.g., side bar, top bar, main application) can enhance system functionality at the expense of the system having a simple, intuitive, and user-friendly user interface and navigation controls. Another way to facilitate user training is to provide user training videos, presentations, documents, or help files. In conventional systems, such approaches can distract users from utilizing the system and force users to context switch between, for example, the project/document management system and the training materials or help files, which can adversely impact productivity.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3A is a block diagram illustrating a hierarchical organization of pages in a workspace, according to some arrangements.

FIG. 3B is an example graphical user interface (GUI) that enables creation of a page, according to some arrangements.

FIG. 3C is an example GUI that enables augmentation of a particular page with artificial intelligence/machine learning (AI/ML) generated content, according to some arrangements.

FIG. 4 is an example GUI showing an entry point for automatically activating a shadow cursor tutorial session, according to some arrangements.

FIG. 5 is an example GUI showing the shadow cursor in operation, according to some arrangements.

FIG. 6 is an example GUI showing an example result of shadow cursor operation, according to some arrangements.

FIG. 7 is an example GUI showing an example end state for a shadow cursor tutorial session, according to some arrangements.

FIG. 8 is a flowchart showing an example method of operation of the shadow cursor, according to some arrangements.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The technology disclosed herein includes improved systems, methods, and computer-readable media for training users on workflows related to managing (e.g., storing, creating, accessing) linked multimodal content (for example, in a block-based data structure, such as the data structures described herein). Multimodal content refers to content items of different types (e.g., text, images, video, audio, multimedia), where the items can be related. For example, a particular conceptual unit of multimodal content can include a project plan, meeting notes, to-do lists, project budgets, stakeholder interview recordings (e.g., in audio and/or video form), and user-interactive multimedia training files.

The systems, methods, and computer-readable media described herein enable a technical advantage of contextually presenting automatically-generated user tutorials as users navigate the system. Accordingly, the techniques described herein can include generating a shadow cursor based on automatically determining a state or user activity within an application. The shadow cursor can move around the screen to simulate a sequence of operations that correspond to a particular workflow.

The shadow cursor can be automatically activated, in an intelligent fashion, based on various conditions. For example, in some implementations, the shadow cursor can be automatically activated when a selector (e.g., mouse pointer controlled by a user) hovers over a particular control displayed on a page. In some implementations, the shadow cursor can be automatically activated by highlighting a particular area on a page that the system has learned (e.g., by utilizing user diaries, logs of user activity, AI/ML analytics) to be a likely entry point for interacting with a particular page. For example, the system can maintain a repository of experiments conducted to determine the effectiveness of various methods of teaching fundamental system skills and use-case specific workflows. The data regarding experiments can be used in determining the likely entry point for interacting with a particular page, in determining the workflow to highlight using the shadow cursor, etc. The data can include various metrics, such as frequencies of activating creator mode, frequencies of activating AI assistant tools, activation rates for various GUI controls or items in the block-based data structure of the system (e.g., creation or modification rates for particular block properties), and so forth. The system can automatically predict that relatively higher frequency rates for users or tasks with particular characteristics (e.g., group membership, role, task) can correspond to particular training workflows (e.g., training on how to create a page) that are most likely of interest to a particular user. In some implementations, the system can, for example, predict top N (e.g., top 3, top 5) training workflows that correspond to the highest frequency rates based on experimental data.

In some implementations, the predictions can be made using a neural network that can be incrementally trained using additional training data sets derived based on live user interactions as users navigate the system. For example, training sets can be generated by intercepting and capturing aspects of user workflows (e.g., by detecting a series of clicks on particular GUI controls). Based on this information, the system can calculate various aggregate metrics, such as the frequencies of activating creator mode, frequencies of activating AI assistant tools, activation rates for various GUI controls, creation or modification rates for particular block properties, and so forth. In an illustrative use case, if users in a particular role or group membership frequently add a specific property to a block (e.g., “due date”, “interim due date”, “reviewer”), the system can automatically predict that a new user in a similar role or group membership should be presented with an automatic training workflow on adding properties to block objects.

The aggregate metrics can be stored in association with user and/or task characteristics (e.g., group membership, role, task). The system can generate vectorized (quantized) representations of user and/or task characteristics. The training data sets can be utilized to determine user similarity to other users, which can, in turn, enable the system to select the top N suggested training workflows for a user.

In some implementations, the shadow cursor feature can be invoked by the user (e.g., by pressing “F1” or another predetermined key or by performing a particular gesture on a touchscreen (e.g., press and hold, double-tap)).

Upon invocation/activation, the shadow cursor can move around the page and guide the user according to an automatically predicted training workflow. For instance, the shadow cursor can instruct users on which items to click and how to gain skills within the platform without requiring the user to read a document, watch a video, or navigate to a help file.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). For example, various engines described herein can automatically analyze and retrieve items (e.g., Rich Text Files (RTF), data, tables, images, audio, multimedia) that are stored and managed using blocks. The blocks are dynamic units of information that can be transformed into other block types and move across workspaces. The block model allows users to customize how their information is moved, organized, and shared. Hence, blocks contain information but are not siloed. The shadow cursor for user tutorials, described further herein, can be configured to interact or visually simulate interactions with various blocks, read block properties, cause block updates or deletions, and so forth.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks or pointers thereto are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. Save Transactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

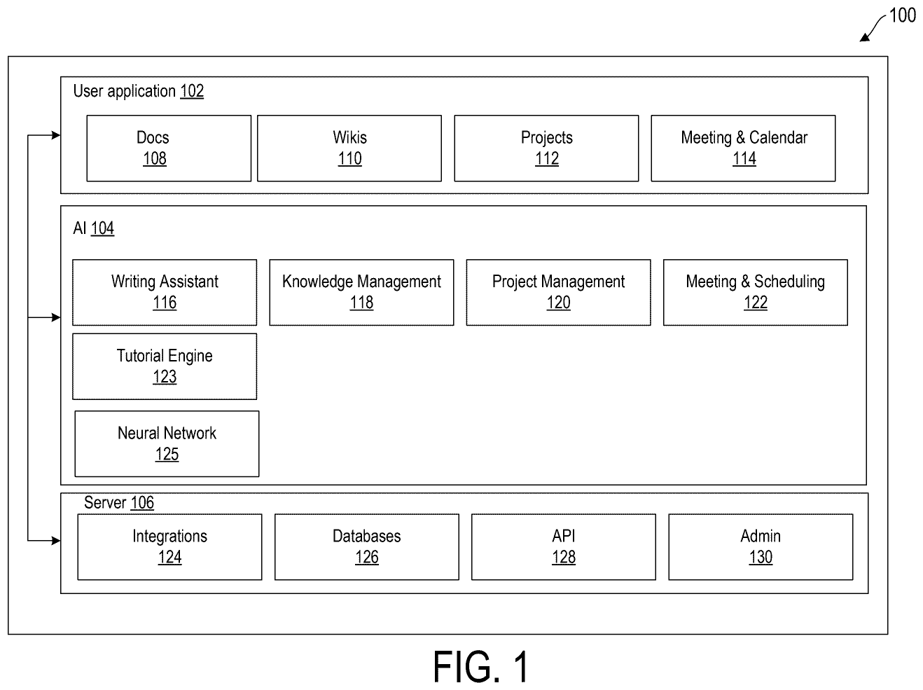

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network. The shadow cursor, described further herein, can be utilized to train users on how to navigate and utilize various features of the example platform 100, including, for example, user applications 102, templates, pages, databases, content, AI/ML features, and so forth.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, and a meeting and calendar template 114. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, and/or other pages (e.g., nested pages or sub-pages). Blocks can be assigned certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, and/or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

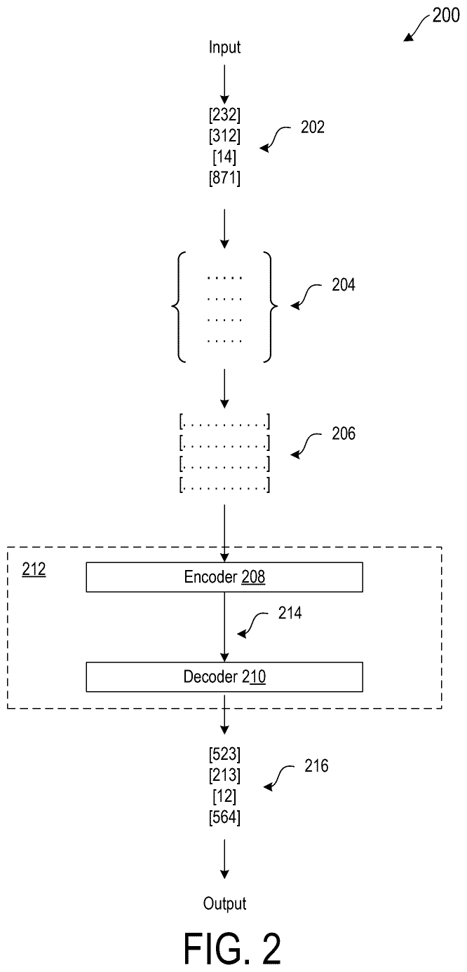

The AI tool 104 is an integrated AI assistant that enables AI-based functions for the user application 102. In one example, the AI tool 104 is based on a neural network architecture, such as the transformer 212 described in FIG. 2. Accordingly, the AI tool 104 can include one or more instances of a neural network 125, which can include model-related data stores, parameter stores, executables, API files, and so forth (collectively, referred to as a model framework). The AI tool 104 can interact with blocks embedded within the templates on a workspace of the user application 102. For example, the AI tool 104 can include a writing assistant tool 116, a knowledge management tool 118, a project management tool 120, a meeting and scheduling tool 122, and/or a tutorial engine 123. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant.

The project management tool 120 can provide AI support for the projects template 112. The AI support can include auto filling information based on changes within the workspace or automatically tracking project development. For example, the project management tool 120 can use AI for task automation, data analysis, real-time monitoring of project development, allocation of resources, and/or risk mitigation.

The meeting and scheduling tool 122 can use AI to organize meeting notes, unify meeting records, list key information from meeting minutes, and/or connect meeting notes with deliverable deadlines.

The tutorial engine 123 can include computer executables, library files, definition files, configuration files, and graphics to enable operation of the shadow cursor, utilized to train users on how to navigate and utilize various features of the platform 100.

Further with respect to elements of the platform 100, the server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc. According to various implementations, the administration unit 130 and/or databases 126 can include various data stores for storage, retrieval and management of ontologies, user accounts, permissions, security settings, AI/ML models, AI/ML frameworks, and so forth.

### Transformer for Neural Network

To assist in understanding the present disclosure, some concepts relevant to neural networks and machine learning (ML) are discussed herein. For example, various features of the platform 100 can include AI/ML components, which can learn or be trained to tailor system operations, workflows, or content to a user, perform tasks (e.g., content generation, content summarization, content searches), or train the user. In the context of training users, certain features of the shadow cursor, described further herein, can include AI/ML components. For example, the platform can learn or make inferences about user workflows, behavior, or characteristics and adapt operations performed by the shadow cursors to these traits. For example, the platform can generate top N training workflows for a particular user by contextualizing the user record or tasks. Contextualizing the user record can include determining user characteristics, generating (e.g., based on the determined user characteristics) a set of other users to which the user is similar, and predicting the top N training workflows for the particular user using historical information for the set of other users.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

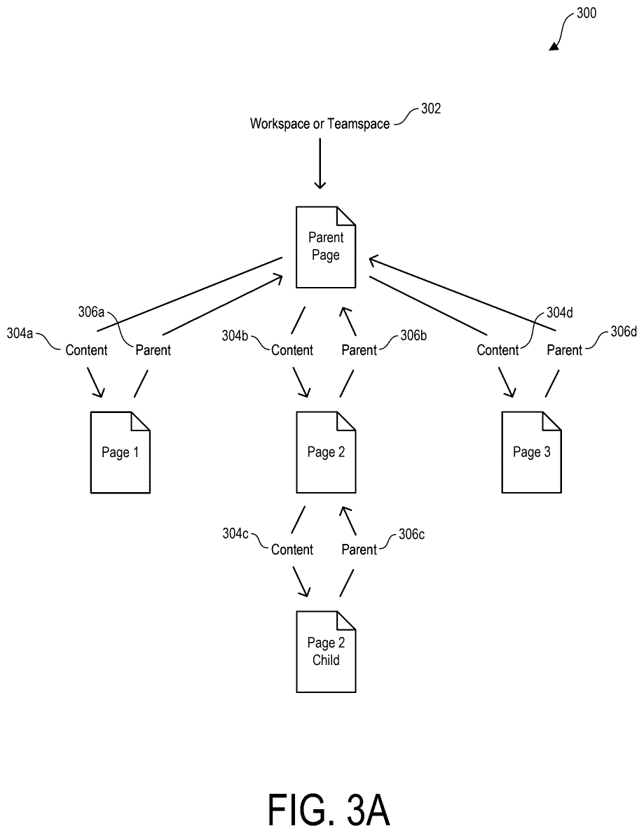

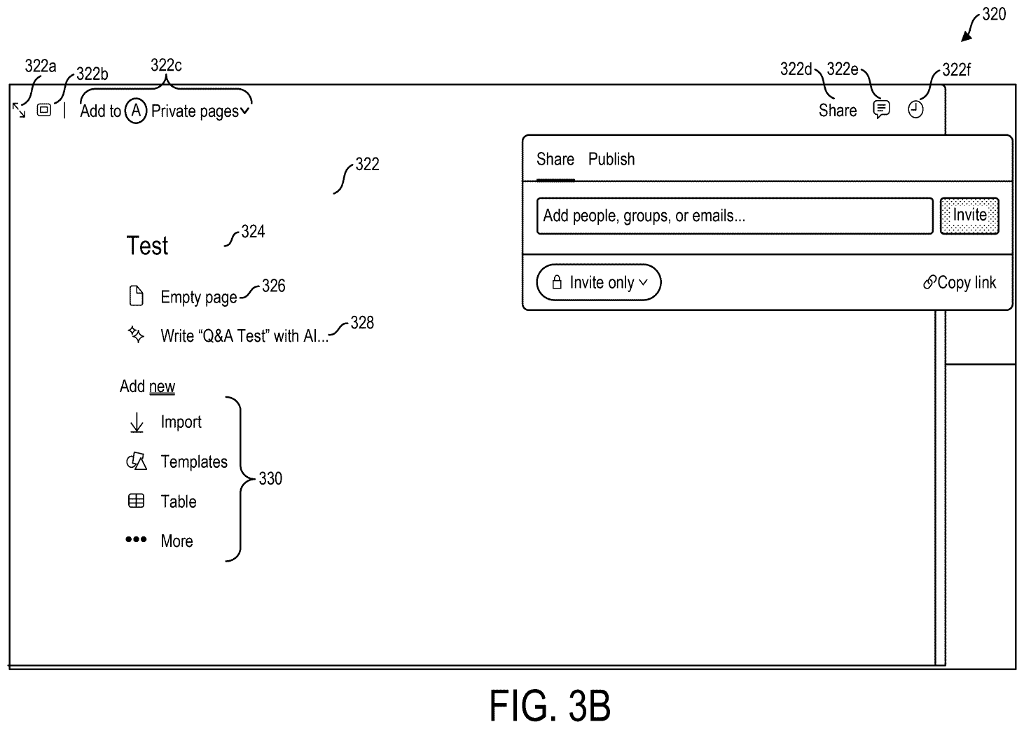

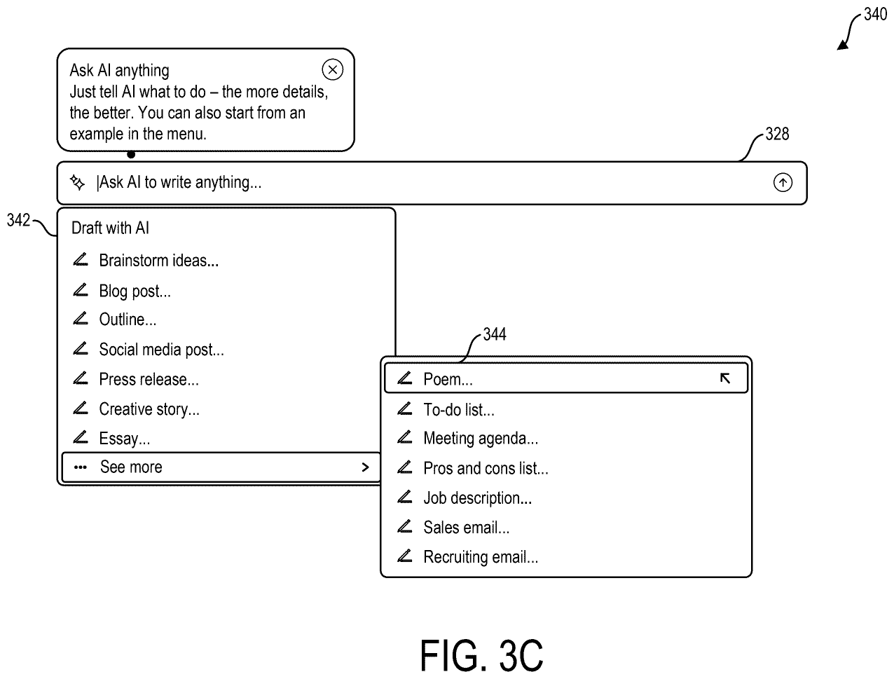

FIG. 3A is a block diagram illustrating a hierarchical organization of pages in a workspace. The shadow cursor for user tutorials, described further herein, can be configured to simulate page- or block-related functionality described here.

As described with respect to the block data model of the present technology, a workspace can include multiple pages (e.g., page blocks). The pages (e.g., including parent pages and child or nested pages) can be arranged hierarchically within the workspace or one or more teamspaces 302, as shown in FIG. 3A. The page can include a block such as tabs, lists, images, tables, etc.

A teamspace 302 can refer to a collaborative space associated with a team or an organization that is hierarchically below a workspace. For example, a workspace can include a teamspace 302 accessible by all users of an organization and multiple teamspaces 302 that are accessible by users of different teams. Accessibility generally refers to creating, editing, and/or viewing content (e.g., pages) included in the workspace or the one or more teamspaces 302.

In the hierarchical organization illustrated in FIG. 3A, a parent page (e.g., “Parent Page”) is located hierarchically below the workspace or a teamspace 302. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows (304a-304d) in FIG. 3A indicate the relationship between the parents and children while the “Parent” arrows (306a-306d) indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3A so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

FIG. 3B is an example graphical user interface (GUI) 320 that enables creation of page(s) 322, according to some arrangements. FIG. 3C is an example GUI 340 that enables augmentation of a particular page with AI-generated content, according to some arrangements. As a general overview, a page can include one or more content blocks and user-interactive controls. The user-interactive controls can enable text writing, text editing, markdown operations, content management (addition, deletion, merging, import, duplication), template management, content customization, file management (e.g., images, video, audio, multimedia), code generation, database generation, project plan generation, block synchronization, and so forth.

Organizing sets of hierarchical blocks in pages provides a host of technical advantages, including the ability to create relational linkages (between blocks and/or pages) in multimodal content, ability to dynamically create multimodal content with various content types added on-demand, ability to synchronize block editing operations when a particular block is included in multiple pages, and ability to optimize multimodal content for AI-based analytical operations such that performance metrics of AI-based models (e.g., accuracy, recall, F-1 score, and so forth) are maximized. For example, when a page includes multimodal content distributed across several blocks, collections of block properties can vary across modalities, which can be represented by blocks, and block properties can serve as built-in data labels to train neural networks on the block structure and content.

A particular page can include textual elements, graphical elements, links, computer-readable code, and/or computer-executable code. As shown in FIG. 3B, an example page 322 includes an expand control 322a, a page positioning control 322b, and an add to control 322c, which enables the user to add the page 322 to a particular teamspace. In some implementations, detecting a user interaction with an add to control 322c causes the GUI 320 to generate and display a list of suggested teamspaces. The list of suggested teamspaces can be determined, for example, by the user's permissions, the user's frequency of interaction with certain teamspaces, the user's recency of interaction with certain teamspaces (e.g., within the past 24 hours, within the past week), and/or the level of authority of a particular teamspace. The example page 322 further includes a share control 322d, which enables the user to cause the platform to generate a link to send to invited collaborators and/or to publish page 322 as a web page. Upon detecting a user interaction indicative of an instruction to publish the page 322 as a web page, the platform can generate and display an additional UI control, which can enable the user to specify a target site, link expiration date, editing permissions, commenting permissions, search engine indexing permissions, settings to enable other people to duplicate a particular public page to their workspaces or teamspaces, and so forth. The example page 322 further includes a view comments control 322e, which enables the user to cause the platform to display comments associated with the page 322. The example page 322 further includes a view changes control 322f, which enables the user to cause the platform to display prior changes associated to content or properties of the page 322.

As shown, the example page 322 further includes a title 324, an empty page control 326, and a prompt block 328. Upon detecting a user interaction with (e.g., clicking on, tapping on, hovering a mouse over) the prompt block 328, the page 322 can cause execution of computer code bound to the prompt block 328. The computer code can, for example, cause the page 320 to generate and display the GUI 340 of FIG. 3C. The GUI 340 can include an expanded prompt block 328, which enables augmentation of the page 320 with content generated by the AI tool 104 of FIG. 1. The user is enabled to enter a natural-language prompt in the prompt block 328, which can trigger, for example, an AI framework (e.g., the transformer framework described in relation to FIG. 2, an LLM, etc.) to generate output in according to the prompt. In some implementations, upon detecting a user interaction with the prompt block 328, the page 322 can cause execution of computer code to display expanded lists 342 and/or 344, which enable the user to further specify prompt elements (e.g., input, context, output, and/or instructions).

As shown, the example page 322 further includes an add new control 330. The add new control 330 enables users to cause the platform to generate content items with predetermined elements, such as format (e.g., a table), layout (e.g., in accordance with a template), and so forth. The add new control 330 can also enable users to import items (e.g., according to specifications, executables, and/or configuration information managed by the integrations 124). Imported items can include, for example, .zip files, HTML files, .csv files, text files, markdown files, third-party system files, and so forth. Additionally, the add new control 330 can enable users to add new templates (e.g., project templates, task templates, product-related templates, startup-related templates, operations-related templates, engineering-related templates, design-related templates, human-resources related templates, IT-related templates and so forth), timelines (e.g., Gantt charts), tables, and so forth.

Various types of pages that can be added via the add new control 330 can have various attributes, which can include properties. Block properties can be utilized, alone or in conjunction with other elements, such as block types, block dependencies, block content values, block content types, and/or block format, to train the neural networks of the AI tool 104.

### Shadow Cursor for User Tutorials

Described in this section is a shadow cursor tutorial that can be presented to a user via a GUI of a page.

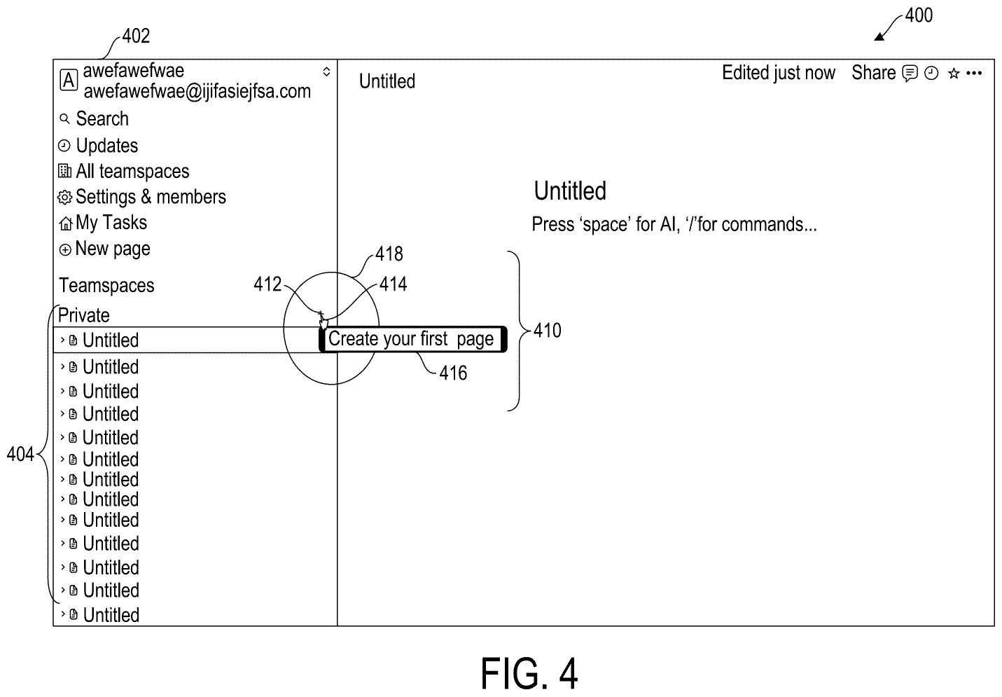

FIG. 4 is an example GUI 400 showing an entry point 412 for automatically activating a shadow cursor tutorial session, according to some arrangements. In some implementations, the entry point 412 can be automatically determined based on a position of a cursor on a particular page. For instance, when the system detects a mouse hover or a tap over a directory control 404 (e.g., a page directory), the system can automatically instantiate and display a particular instance of a shadow cursor 410. The shadow cursor 410 can bring a particular GUI element (e.g., entry point 412) in focus. In an example implementation, the shadow cursor 410 can include components that are configured to visually emphasize a particular area on the GUI 400. For example, as shown, the shadow cursor 410 can include various cursor properties, such as a configurable mask image (e.g., pointer element 414, which can include a graphic), an instruction 416 (e.g., a user instruction string), and a radial gradient 418.

In some implementations, the radial gradient 418 can have a luminance (color), saturation or opacity value that is set to meet or exceed a particular threshold in relation to the background. For example, a contrast ratio can be calculated by dividing a first relative luminance value of the color of the radial gradient 418, or a mathematical function thereof, by a second relative luminance value of the color of the background, or a mathematical function thereof. The colors can be selected such that the ratio is at least 3:1, 4.5:1, and so forth. For example, a first saturation and/or opacity of the radial gradient 418 can be programmatically set to be no greater or no less than than a predetermined percentage threshold, such as 50%, 75% and so forth, relative to the saturation or opacity of the background. One of skill will appreciate that other suitable techniques for determining thresholds can be utilized to achieve the goal of visually emphasizing the radial gradient 418 relative to the background. Some example techniques are described, for instance, in the Web Content Accessibility Guidelines (WCAG) 2.2 by the World Wide Web Consortium (W3C).

In an example use case, the shadow cursor 410 is activated to demonstrate to the user how to create a new page. In some implementations, the system can activate the shadow cursor 410 based on automatically determining that the user has not previously created a page. Other factors that can be used to make the automatic determination in order to position the shadow cursor 410 on the screen (and/or in order to cause the shadow cursor 410 to demonstrate how to perform specific operations in a particular training workflow predicted for the particular user) can include recency of the user account, user role, history of user interactions with the system, user profile characteristics, user similarity score, history of content creation by the user, or a combination thereof.

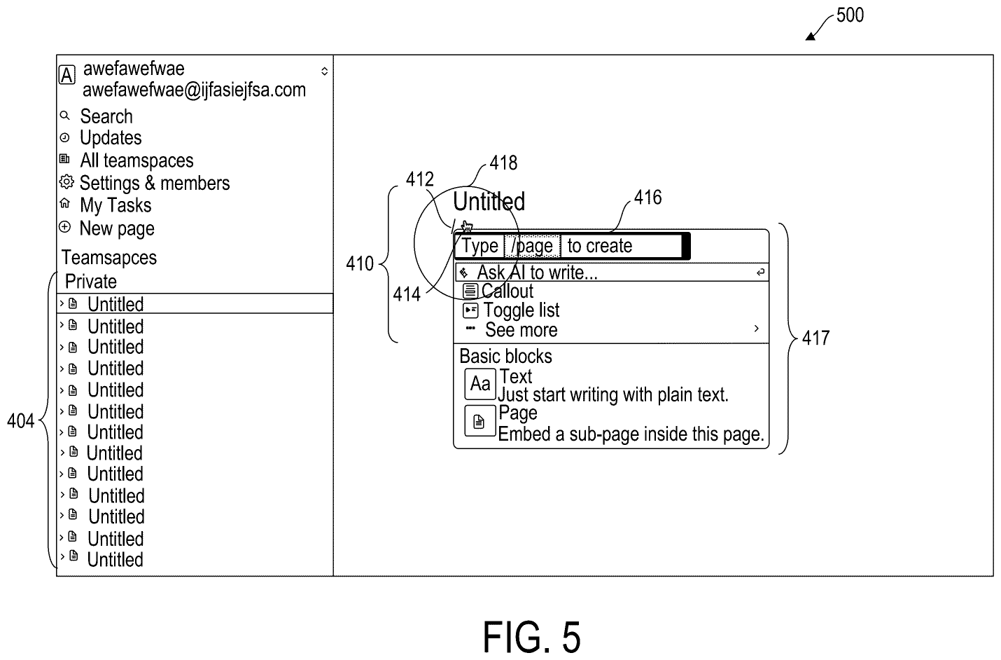

FIG. 5 is an example GUI 500 showing the shadow cursor 410 in operation, according to some arrangements. In some implementations, rather than training users on system features in isolation, the system can cause the shadow cursor 410 to move around the GUI 500 to contextually demonstrate how to perform a task or complete a particular workflow. For example, the tutorial can include an automatically generated training workflow. The training workflow can include an animation that shows the movement of the shadow cursor 410 and its interactions with objects on the GUI 500. In such instances, a user-controlled cursor (e.g., for a live application) can be operated concurrently with the shadow cursor 410 but independently of the animation to enable the user to follow along and complete the workflow.

As shown according to an example, the system can automatically position the shadow cursor 410 over a GUI control configured to accept user commands (e.g., a user command to create a new page). The shadow cursor 410 can then be caused to display updated elements 412-416 based on the nature of the demonstrated operation in the predicted training workflow. For example, the entry point 412 for the particular operation can be updated to replace a first graphic (e.g., a plus sign for creating a page) with a second graphic (e.g., a forward slash for enabling user to enter instructions). The instruction 416 is a contextual usage instruction that can be updated to display a command that can teach the user about the operation (e.g., “Type/page to create a page”). The displayed user instruction string can include a substring showing a command (“/page”) and an explanation or context that guides the user regarding what to do (“type”) to perform a task or achieve an outcome (“to create a page”). A menu 417 can include a graphic that can simulate a live menu that would appear if the user were to perform the page creation operation or, more generally, any operation demonstrated by the shadow cursor 410. The menu 417 can include additional options for interacting with or configuring the created page, for example.

One of skill will appreciate that a training workflow demonstrated by a particular shadow cursor 410 can include multiple operations. For example, the shadow cursor 410 can be caused to navigate to a particular menu 417 item to demonstrate the functionality of such an item. Additionally, although page creation is shown as an illustrative example, other features of the system can be simulated using one or more sessions or instances of the shadow cursor 410.

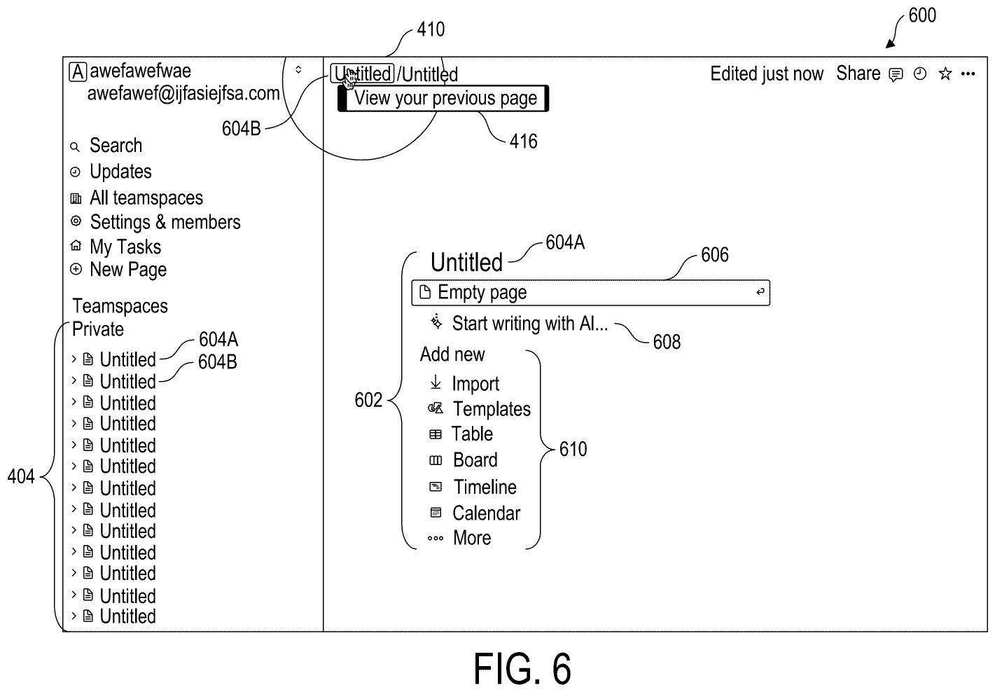

FIG. 6 is an example GUI 600 showing an example result 602 of operation of the shadow cursor 410, according to some arrangements. As shown, the system can display a control or a simulation of a control that can be populated after the operation previously demonstrated by the shadow cursor 410 is performed. For instance, the system can display an example new page created in response to the/page command previously demonstrated by the shadow cursor 410. The new page can include various elements, such as the title 604a, status 606, AI prompt 608, and page-specific controls 610 (e.g., controls for further operations that can be performed on a newly created page, such as import, template management, table management, and so forth). As shown, the directory control 404 can be updated or populated to include links to the newly created page (title 604a) and previously created page (title 604b). In some implementations, the shadow cursor 410 can be positioned in another, different area of the page (e.g., the page navigator), and the instruction 416 can be updated to provide additional context that can instruct the user how to further interact with the system.

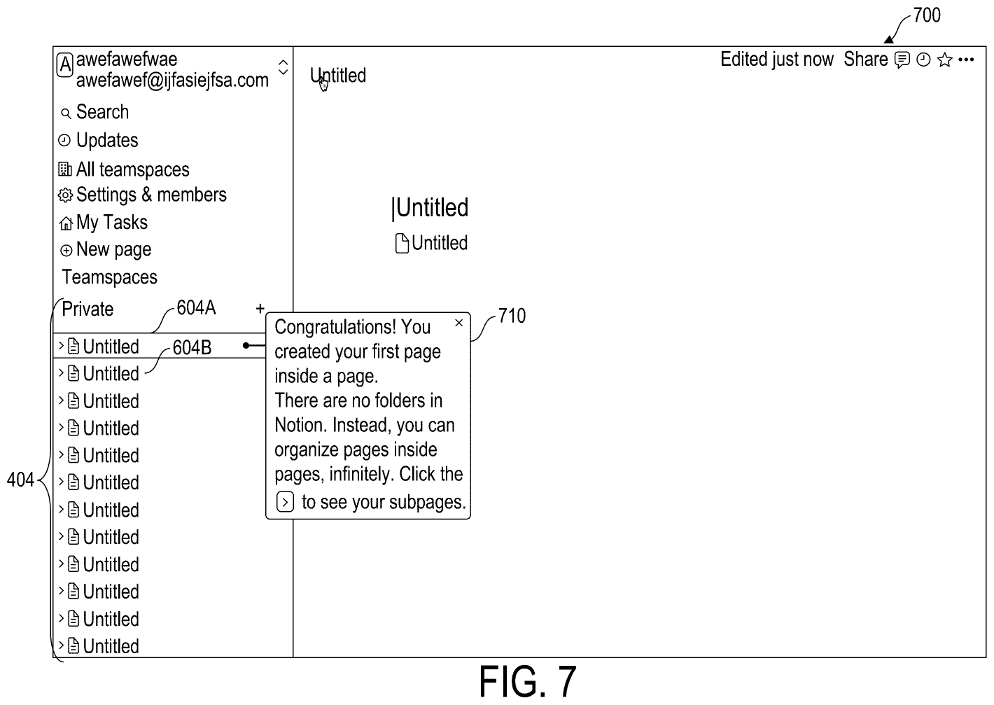

FIG. 7 is an example GUI 700 showing an example end state for a shadow cursor 410 tutorial session, according to some arrangements. In an example, the system can position the shadow cursor 410 in an area of the page that shows the result of the shadow cursor operation and can further display an exit status message 710 (e.g., “Congratulations! You have created your first page.”)

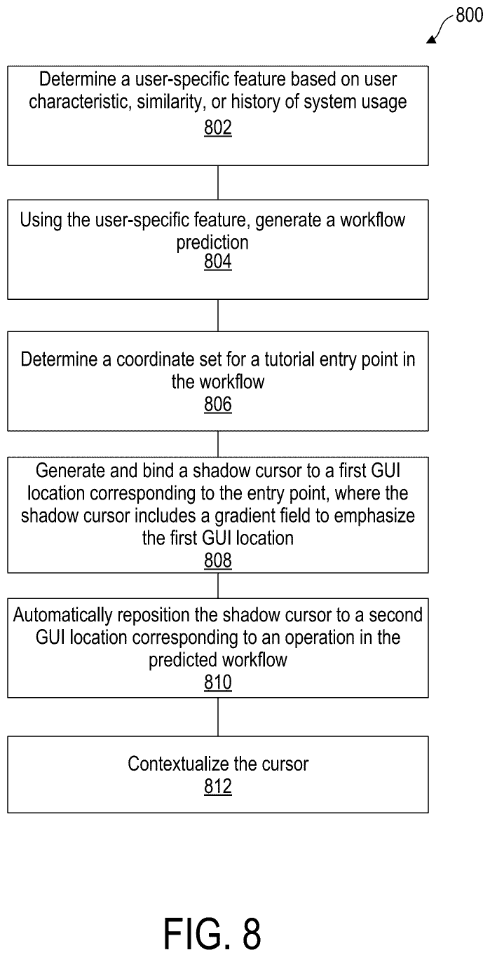

FIG. 8 is a flowchart showing an example method of operation 800 of the shadow cursor, according to some arrangements. Method of operations 800 can be performed, in whole or in part, by the tutorial engine 123 or another suitable computing system or component thereof.

As shown, at 802, the tutorial engine 123 can determine a user-specific feature—for example, an input feature to a neural network or another executable component that can, at 804, generate a workflow prediction for the user. The user-specific feature can include one or more of a user characteristic, user similarity measure relative to other users, history of system usage by the user, history of system usage by similar users, and so forth. For example, if the user never previously created a page, the tutorial engine 123 can generate a workflow prediction that will relate to generating the user's first page. The workflow prediction can include specific operations, such as showing the page creation entry point to a user, showing the page creation prompts, showing the AI editor, showing the/page command, showing how to set page properties, and so forth.

At 806, the tutorial engine 123 can determine a set of x- and y-coordinates on the GUI for the entry point in the determined workflow. Then, at 808, the tutorial engine 123 can generate a shadow cursor, which can be bound to the entry point (that is, set to have coordinates that correspond to the entry point). The cursor can have a gradient field (e.g., a field of a predetermined radius, such as 1 cm, 1 in, 1,000 pixels, etc.) relative to its center. The gradient field can emphasize the relevant controls on the GUI to facilitate user training.

At 810, the tutorial engine 123 can automatically reposition the shadow cursor on the screen to simulate a sequence of operations in the predicted workflow. At 812 (e.g., as the cursor is repositioned at each step), the tutorial engine 123 can set cursor properties to provide further information or context about the demonstrated operation. Cursor properties can include a configurable mask image (e.g., pointer element 414, which can include a graphic), an instruction 416 (e.g., a user instruction string), and a radial gradient 418. For example, the tutorial engine 123 can set radial gradient 418 to blink, pulse, change in size and so forth as the cursor is repositioned to a GUI element that corresponds to a next/new step in the training workflow. For example, the tutorial engine 123 can set or change a graphic of the pointer element 414 as the cursor is repositioned.

### Computer System

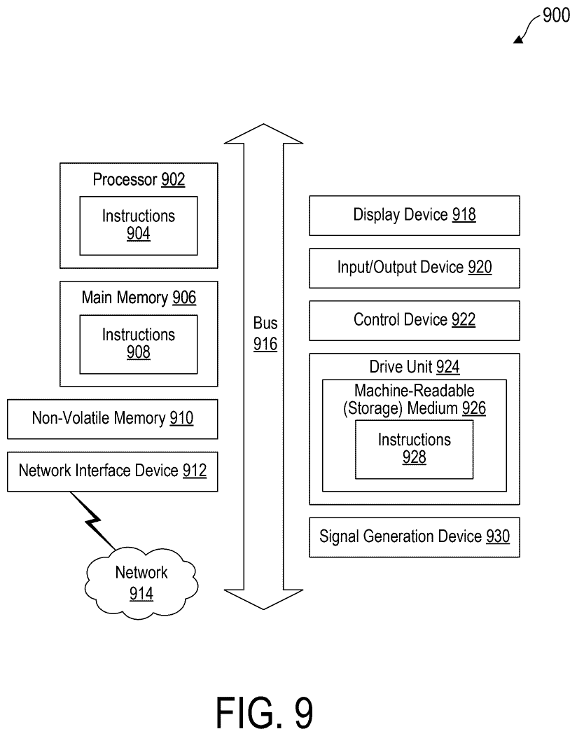

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a machine readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### EXAMPLES

Aspects of the present disclosure can be further understood using non-exhaustive, non-limiting examples.

In some aspects, the techniques described herein relate to one or more non-transitory, computer-readable storage media including instructions recorded thereon, wherein the instructions, when executed by at least one data processor of a computing system, cause the computing system to: determine a set of x- and y-coordinates on a graphical user interface (GUI), wherein the x- and y-coordinates correspond to an entry point for a user tutorial session; generate and bind, to the determined set of x- and y-coordinates, a shadow cursor, the shadow cursor including a radial gradient configured to visually emphasize a portion of the GUI within a predetermined radius relative to the x- and y-coordinates; automatically position the shadow cursor in a first location on the GUI, the first location corresponding to the x- and y-coordinates; using a trained model, generate a prediction of a training workflow for a user, wherein the training workflow includes a set of operations on the GUI; and for an operation in the determined set of operations of the predicted training workflow, automatically position the shadow cursor in a second location on the GUI.

In some aspects, the techniques described herein relate to a media, wherein the instructions to determine the set of x- and y-coordinates, when executed by the at least one data processor of the computing system, cause the computing system to: determine a user-specific feature, wherein the user-specific feature relates to a user characteristic or system usage history; using the determined user-specific feature, generate the prediction of the training workflow for the user; identify, on the GUI, a starting point for the determined workflow; and determine the set of x- and y-coordinates for the entry point for the user tutorial session using coordinates of the identified starting point.

In some aspects, the techniques described herein relate to a media, wherein the user-specific feature is automatically determined, by a neural network, based on user similarity to other system users.

In some aspects, the techniques described herein relate to a media, wherein the shadow cursor further includes a user instruction string, and wherein the instructions, when executed by the at least one data processor of a computing system, cause the computing system to: determine an executable system command that corresponds to the first location or the second location on the GUI; and generate the user instruction string to include a visual or textual representation of the executable system command.

In some aspects, the techniques described herein relate to a media, wherein the user instruction string further includes contextual usage instructions.

In some aspects, the techniques described herein relate to a media, wherein the contextual usage instructions are automatically generated using at least the executable system command as an input.

In some aspects, the techniques described herein relate to a media, wherein the contextual usage instructions are automatically generated using at least one of the user characteristic or system usage history.

In some aspects, the techniques described herein relate to a computing system having at least one data processor and one or more non-transitory, computer-readable storage media including instructions recorded thereon, wherein the instructions, when executed by the at least one data processor, cause the computing system to: determine a set of x- and y-coordinates on a graphical user interface (GUI), wherein the x- and y-coordinates correspond to an entry point for a user tutorial session; generate and bind, to the determined set of x- and y-coordinates, a shadow cursor, the shadow cursor including a radial gradient configured to visually emphasize a portion of the GUI within a predetermined radius relative to the x- and y-coordinates; automatically position the shadow cursor in a first location on the GUI, the first location corresponding to the x- and y-coordinates; using a trained model, generate a prediction of a training workflow for a user, wherein the training workflow includes a set of operations on the GUI; and for an operation in the determined set of operations of the predicted training workflow, automatically position the shadow cursor in a second location on the GUI.

In some aspects, the techniques described herein relate to a computing system, wherein the instructions to determine the set of x- and y-coordinates, when executed by the at least one data processor of the computing system, cause the computing system to: determine a user-specific feature, wherein the user-specific feature relates to a user characteristic or system usage history; using the determined user-specific feature, generate the prediction of the training workflow for the user; identify, on the GUI, a starting point for the determined workflow; and determine the set of x- and y-coordinates for the entry point for the user tutorial session using coordinates of the identified starting point.

In some aspects, the techniques described herein relate to a computing system, wherein the user-specific feature is automatically determined, by a neural network, based on user similarity to other system users.

In some aspects, the techniques described herein relate to a computing system, wherein the shadow cursor further includes a user instruction string, and wherein the instructions, when executed by the at least one data processor of a computing system, cause the computing system to: determine an executable system command that corresponds to the first location or the second location on the GUI; and generate the user instruction string to include a visual or textual representation of the executable system command.

In some aspects, the techniques described herein relate to a computing system, wherein the user instruction string further includes contextual usage instructions.

In some aspects, the techniques described herein relate to a computing system, wherein the contextual usage instructions are automatically generated using at least the executable system command as an input.

In some aspects, the techniques described herein relate to a computing system, wherein the contextual usage instructions are automatically generated using at least one of the user characteristic or system usage history.

In some aspects, the techniques described herein relate to a computer-implemented method including: determining a set of x- and y-coordinates on a graphical user interface (GUI) of a computing system, wherein the x- and y-coordinates correspond to an entry point for a user tutorial session; generating and binding, to the determined set of x- and y-coordinates, a shadow cursor, the shadow cursor including a radial gradient configured to visually emphasize a portion of the GUI within a predetermined radius relative to the x- and y-coordinates; automatically positioning the shadow cursor in a first location on the GUI, the first location corresponding to the x- and y-coordinates; using a trained model, generating a prediction of a training workflow for a user, wherein the training workflow includes a set of operations on the GUI; and for an operation in the determined set of operations of the predicted training workflow, automatically positioning the shadow cursor in a second location on the GUI.

In some aspects, the techniques described herein relate to a method, further including: determining a user-specific feature, wherein the user-specific feature relates to a user characteristic or system usage history; using the determined user-specific feature, generating the prediction of the training workflow for the user; identifying, on the GUI, a starting point for the determined workflow; and determining the set of x- and y-coordinates for the entry point for the user tutorial session using coordinates of the identified starting point.

In some aspects, the techniques described herein relate to a method, wherein the user-specific feature is automatically determined, by a neural network, based on user similarity to other system users.

In some aspects, the techniques described herein relate to a method, wherein the shadow cursor further includes a user instruction string, the method further including: determining an executable system command that corresponds to the first location or the second location on the GUI; and generating the user instruction string to include a visual or textual representation of the executable system command.

In some aspects, the techniques described herein relate to a method, wherein the user instruction string further includes contextual usage instructions.

In some aspects, the techniques described herein relate to a method, wherein the contextual usage instructions are automatically generated using at least the executable system command as an input.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. One or more non-transitory, computer-readable storage media comprising instructions recorded thereon, wherein the instructions, when executed by at least one data processor of a computing system, cause the computing system to:
determine a set of x- and y-coordinates on a graphical user interface (GUI), wherein the x- and y-coordinates correspond to an entry point for a user tutorial session;
generate and bind, to the determined set of x- and y-coordinates, a shadow cursor, the shadow cursor comprising a radial gradient configured to visually emphasize a portion of the GUI within a predetermined radius relative to the x- and y-coordinates;
automatically position the shadow cursor in a first location on the GUI, the first location corresponding to the x- and y-coordinates;
using a trained model, generate a prediction of a training workflow for a user, wherein the training workflow comprises a set of operations on the GUI; and
for an operation in the determined set of operations of the predicted training workflow, automatically position the shadow cursor in a second location on the GUI.

2. The media of claim 1, wherein the instructions to determine the set of x- and y-coordinates, when executed by the at least one data processor of the computing system, cause the computing system to:
determine a user-specific feature, wherein the user-specific feature relates to a user characteristic or system usage history;
using the determined user-specific feature, generate the prediction of the training workflow for the user;
identify, on the GUI, a starting point for the determined workflow; and
determine the set of x- and y-coordinates for the entry point for the user tutorial session using coordinates of the identified starting point.

3. The media of claim 2, wherein the user-specific feature is automatically determined, by a neural network, based on user similarity to other system users.

4. The media of claim 2, wherein the shadow cursor further comprises a user instruction string, and wherein the instructions, when executed by the at least one data processor of a computing system, cause the computing system to:
determine an executable system command that corresponds to the first location or the second location on the GUI; and
generate the user instruction string to include a visual or textual representation of the executable system command.

5. The media of claim 4, wherein the user instruction string further includes contextual usage instructions.

6. The media of claim 5, wherein the contextual usage instructions are automatically generated using at least the executable system command as an input.

7. The media of claim 6, wherein the contextual usage instructions are automatically generated using at least one of the user characteristic or system usage history.

8. A computing system having at least one data processor and one or more non-transitory, computer-readable storage media comprising instructions recorded thereon, wherein the instructions, when executed by the at least one data processor, cause the computing system to:
determine a set of x- and y-coordinates on a graphical user interface (GUI), wherein the x- and y-coordinates correspond to an entry point for a user tutorial session;
generate and bind, to the determined set of x- and y-coordinates, a shadow cursor, the shadow cursor comprising a radial gradient configured to visually emphasize a portion of the GUI within a predetermined radius relative to the x- and y-coordinates;
automatically position the shadow cursor in a first location on the GUI, the first location corresponding to the x- and y-coordinates;
using a trained model, generate a prediction of a training workflow for a user, wherein the training workflow comprises a set of operations on the GUI; and
for an operation in the determined set of operations of the predicted training workflow, automatically position the shadow cursor in a second location on the GUI.

9. The computing system of claim 8, wherein the instructions to determine the set of x- and y-coordinates, when executed by the at least one data processor of the computing system, cause the computing system to:
determine a user-specific feature, wherein the user-specific feature relates to a user characteristic or system usage history;
using the determined user-specific feature, generate the prediction of the training workflow for the user;
identify, on the GUI, a starting point for the determined workflow; and
determine the set of x- and y-coordinates for the entry point for the user tutorial session using coordinates of the identified starting point.

10. The computing system of claim 9, wherein the user-specific feature is automatically determined, by a neural network, based on user similarity to other system users.

11. The computing system of claim 9, wherein the shadow cursor further comprises a user instruction string, and wherein the instructions, when executed by the at least one data processor of a computing system, cause the computing system to:
determine an executable system command that corresponds to the first location or the second location on the GUI; and
generate the user instruction string to include a visual or textual representation of the executable system command.

12. The computing system of claim 11, wherein the user instruction string further includes contextual usage instructions.

13. The computing system of claim 12, wherein the contextual usage instructions are automatically generated using at least the executable system command as an input.

14. The computing system of claim 13, wherein the contextual usage instructions are automatically generated using at least one of the user characteristic or system usage history.

15. A computer-implemented method comprising:
determining a set of x- and y-coordinates on a graphical user interface (GUI) of a computing system, wherein the x- and y-coordinates correspond to an entry point for a user tutorial session;
generating and binding, to the determined set of x- and y-coordinates, a shadow cursor, the shadow cursor comprising a radial gradient configured to visually emphasize a portion of the GUI within a predetermined radius relative to the x- and y-coordinates;
automatically positioning the shadow cursor in a first location on the GUI, the first location corresponding to the x- and y-coordinates;
using a trained model, generating a prediction of a training workflow for a user, wherein the training workflow comprises a set of operations on the GUI; and
for an operation in the determined set of operations of the predicted training workflow, automatically positioning the shadow cursor in a second location on the GUI.

16. The method of claim 15, further comprising:
determining a user-specific feature, wherein the user-specific feature relates to a user characteristic or system usage history;
using the determined user-specific feature, generating the prediction of the training workflow for the user;
identifying, on the GUI, a starting point for the determined workflow; and
determining the set of x- and y-coordinates for the entry point for the user tutorial session using coordinates of the identified starting point.

17. The method of claim 16, wherein the user-specific feature is automatically determined, by a neural network, based on user similarity to other system users.

18. The method of claim 16, wherein the shadow cursor further comprises a user instruction string, the method further comprising:
determining an executable system command that corresponds to the first location or the second location on the GUI; and
generating the user instruction string to include a visual or textual representation of the executable system command.

19. The method of claim 18, wherein the user instruction string further includes contextual usage instructions.

20. The method of claim 19, wherein the contextual usage instructions are automatically generated using at least the executable system command as an input.
